(19) United States
(12) Patent Application Publication
(10) Pub. No.: US 2025/0029756 A1
(43) Pub. Date: Jan. 23, 2025

(54) OVER-CURRENT PROTECTION DEVICE

(71) Applicant: Polytronics Technology Corp., Hsinchu (TW)

(72) Inventors: CHENG-YU TUNG, Tainan City (TW); Chia-Yuan Lee, Hsinchu City (TW); HSIU-CHE YEN, Taoyuan City (TW); CHINGTING CHIU, Taoyuan City (TW); CHEN-NAN LIU, Changhua County (TW); YUNG-HSIEN CHANG, Douliu City (TW); Yao-Te Chang, Yunlin County (TW); FU-HUA CHU, TAIPEI CITY (TW)

(21) Appl. No.: 18/419,761

(22) Filed: Jan. 23, 2024

(30) Foreign Application Priority Data
Jul. 12, 2023 (TW) 112125970

(51) Int. Cl. H01C 7/13; H01C 1/14; H01C 7/02; H02H 9/02

(52) U.S. Cl. CPC H01C 7/13; H01C 1/1406; H01C 7/021; H01C 7/027; H02H 9/026

(57) ABSTRACT

An over-current protection device includes an electrode layer and a heat-sensitive layer. The heat-sensitive layer exhibits a positive temperature coefficient (PTC) characteristic, and is laminated between a top metal layer and a bottom metal layer of the electrode layer. The heat-sensitive layer includes a polymer matrix and a conductive filler. The polymer matrix includes a first fluoropolymer and a second fluoropolymer. The first fluoropolymer includes a first melting point, and the second fluoropolymer has a second melting point lower than the first melting point. The difference between the first melting point and the second melting point is smaller than 14° C. The second fluoropolymer has a second melt flow index ranging from 0.4 g/10 min to 0.7 g/10 min.

### BACKGROUND OF THE INVENTION

### (1) Field of the Invention

The present application relates to an over-current protection device, and more specifically, to an over-current protection device having excellent electrical resistance stability and voltage endurance capability.

### (2) Description of the Related Art

Because the electrical resistance of conductive composite materials having a positive temperature coefficient (PTC) characteristic is very sensitive to temperature variation, they can be used as the materials for current sensing devices and have been widely applied to over-current protection devices or circuit devices. More specifically, the electrical resistance of the PTC conductive composite material remains extremely low at normal temperatures, so that the circuit or battery cell can operate normally. However, when an over-current or an over-temperature situation occurs in the circuit or cell, the electrical resistance will instantaneously increase to a high electrical resistance state (e.g., at least above 10⁴ Ω, which is the so-called “trip”. Therefore, the over-current will be eliminated so as to protect the cell or the circuit device.

The basic structure of an over-current protection device consists of a PTC material layer with two electrodes bonded to two opposite sides of the PTC material layer. The PTC material layer includes a matrix and a conductive filler. The matrix consists of at least one polymer, and the conductive filler is uniformly dispersed in the matrix and is used as an electrically conductive path. In order to meet the requirement of overheating protection at higher temperature, a fluoropolymer (e.g., polyvinylidene difluoride) is generally selected as the major constituent in the matrix. Conventionally, the melting point of the fluoropolymer may be lowered for easier processing, leading to a lower melting point of the overall polymer matrix. As a result, the overall polymer matrix is more prone to melting at the high temperature, which is advantageous for blending and subsequently pressing the materials at high temperature to form the PTC material layer. However, during the trip event, the over-current protection device is under the high temperature condition, and the low-melting-point fluoropolymer may cause structural instability of the PTC material layer, thus compromising the function for structural support and the integrity of the overall structure of the over-current protection device. Moreover, after multiple trip events, the electrical resistance of the conventional over-current protection device would not easily return to a low electrical resistance state at room temperature. As miniaturization becomes a trend in over-current protection devices, the structural instability and other issues derived from that could become more severe with decreasing device size (especially device thickness).

Accordingly, there is still room for enhancement in terms of electrical resistance stability and other electrical characteristics of over-current protection device while improving device processability.

### SUMMARY OF THE INVENTION

The present invention provides an over-current protection device with excellent electrical resistance stability and voltage endurance capability. The over-current protection device of the present invention has an electrode layer and a heat-sensitive layer, and the heat-sensitive layer includes a polymer matrix and a conductive filler. In order to enhance the structural stability of the heat-sensitive layer, the polymer matrix include at least two fluoropolymers (referred to as “first fluoropolymer” and “second fluoropolymer” hereinafter) as its major constituent. The second fluoropolymer, with a lower flowability and a melt flow index ranging from 0.4 g/10 min to 0.7 g/10 min, offers structural support to the heat-sensitive layer and enhances its stability during the high-temperature operation. In addition, the melting point of the second fluoropolymer is lower than the melting point of the first fluoropolymer, which is favorable to the recrystallization process. The second fluoropolymer can rapidly recrystallize by using the first fluoropolymer as a nucleation center, while also providing better structural stability. Accordingly, the electrical characteristics of the over-current protection device is greatly improved. The over-current protection device of the present invention not only withstands high voltage or high power but also shows an improved resistance stability, particularly exhibiting significant stability in the high electrical resistance state after tripping.

In accordance with an aspect of the present invention, an over-current protection device includes an electrode layer and a heat-sensitive layer. The electrode layer has a top metal layer and a bottom metal layer, and the heat-sensitive layer contacts the top metal layer and the bottom metal layer, and is laminated therebetween. The heat-sensitive layer exhibits a positive temperature coefficient (PTC) characteristic and includes a polymer matrix and a conductive filler. The polymer matrix includes a first fluoropolymer and a second fluoropolymer. The first fluoropolymer has a first melting point and a first melt flow index. The second fluoropolymer has a second melting point lower than the first melting point, and a difference between the first melting point and the second melting point is less than 14° C. The second fluoropolymer has a second melt flow index ranging from 0.4 g/10 min to 0.7 g/10 min. The conductive filler is dispersed in the polymer matrix, thereby forming an electrically conductive path in the heat-sensitive layer.

In an embodiment, the difference between the first melting point and the second melting point ranges from 5° C. to 14° C.

In an embodiment, the total volume of the heat-sensitive layer is calculated as 100%, and the first fluoropolymer accounts for 28% to 48% and the second fluoropolymer accounts for 10% to 30% by volume.

In an embodiment, the second fluoropolymer is represented by a structural formula (I):

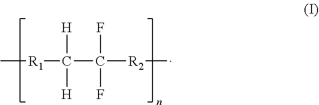

R₁ and R₂ are selected from the group consisting of CH₂, CF₂, CHF, C₂HF₃, C₂H₂F₂, C₂H₃F, C₂H₄, and C₂F₄. R₁ is different from R₂, and n is at least 9000.

In an embodiment, the second melting point of the second fluoropolymer ranges from 168° C. to 174° C.

In an embodiment, the first melt flow index ranges from 0.8 g/10 min to 1.4 g/10 min.

In an embodiment, the second fluoropolymer is polyvinylidene difluoride.

In an embodiment, the polymer matrix further includes a third fluoropolymer. The third fluoropolymer is selected from the group consisting of polytetrafluoroethylene, ethylene-tetrafluoroethylene copolymer, tetrafluoroethylene-hexafluoro-propylene copolymer, perfluoroalkoxy modified tetrafluoroethylenes, poly(chlorotri-fluorotetrafluoroethylene), vinylidene fluoride-tetrafluoroethylene copolymer, tetrafluoroethylene-perfluorodioxole copolymer, vinylidene fluoride-hexafluoropropylene copolymer, vinylidene fluoride-hexafluoropropylene-tetrafluoroethylene terpolymer, and any combination thereof.

In an embodiment, the third fluoropolymer is polytetrafluoroethylene, wherein the total volume of the heat-sensitive layer is calculated as 100%, and polytetrafluoroethylene accounts for 4% to 6% by volume.

In an embodiment, the heat-sensitive layer further includes a flame retardant. The flame retardant is selected from the group consisting of zinc oxide, antimony oxide, aluminum oxide, silicon oxide, calcium carbonate, magnesium sulfate, barium sulfate, magnesium hydroxide, aluminum hydroxide, calcium hydroxide, barium hydroxide, and any combination thereof.

In an embodiment, the conductive filler consists of carbon black.

In an embodiment, the over-current protection device has a first resistance-jump ratio ranging from 1.3 to 1.5, wherein the over-current protection device has an initial electrical resistance; the over-current protection device has a second electrical resistance when cooled back to room temperature after being applied at 16V/40 A for 3 minutes; and the first resistance-jump ratio is obtained by dividing the second electrical resistance by the initial electrical resistance.

In an embodiment, the over-current protection device has a second resistance-jump ratio ranging from 1.5 to 1.8, wherein the over-current protection device has an initial electrical resistance; the over-current protection device has a third electrical resistance when cooled back to room temperature after a cycle life test with an applied power of 30V/40 A for 2000 cycles; and the second resistance-jump ratio is obtained by dividing the third electrical resistance by the initial electrical resistance.

In an embodiment, a standard deviation of the third electrical resistance ranges from 0.0009 Ω to 0.0011 Ω.

In an embodiment, the heat-sensitive layer has a thickness ranging from 0.11 mm to 0.17 mm, and an endurable power of the over-current protection device ranges from 1400 W to 1500 W.

In an embodiment, the over-current protection device has a thermal derating ratio of trip current ranging from 35% to 42%, wherein the thermal derating ratio of trip current is obtained by dividing a required trip current of the over-current protection device under 125° C. by a required trip current of the over-current protection device under 25° C., and is represented by percentage.

In an embodiment, the over-current protection device has a peak-resistance maintenance ratio ranging from 0.4 to 1.1, wherein the over-current protection device has a first peak resistance after tripping at 200° C. for one time; the over-current protection device has a second peak resistance after tripping at 200° C. for three times; and the peak-resistance maintenance ratio is obtained by dividing the second peak resistance by the first peak resistance.

### BRIEF DESCRIPTION OF THE DRAWINGS

The present application will be described according to the appended drawings in which:

FIG. 1 shows a cross-sectional view of an over-current protection device in accordance with an embodiment of the present invention; and

FIG. 2 shows the top view of the over-current protection device shown in FIG. 1.

### DETAILED DESCRIPTION OF THE INVENTION

The making and using of the presently preferred illustrative embodiments are discussed in detail below. It should be appreciated, however, that the present application provides many applicable inventive concepts that can be embodied in a wide variety of specific contexts. The specific illustrative embodiments discussed are merely illustrative of specific ways to make and use the invention, and do not limit the scope of the invention.

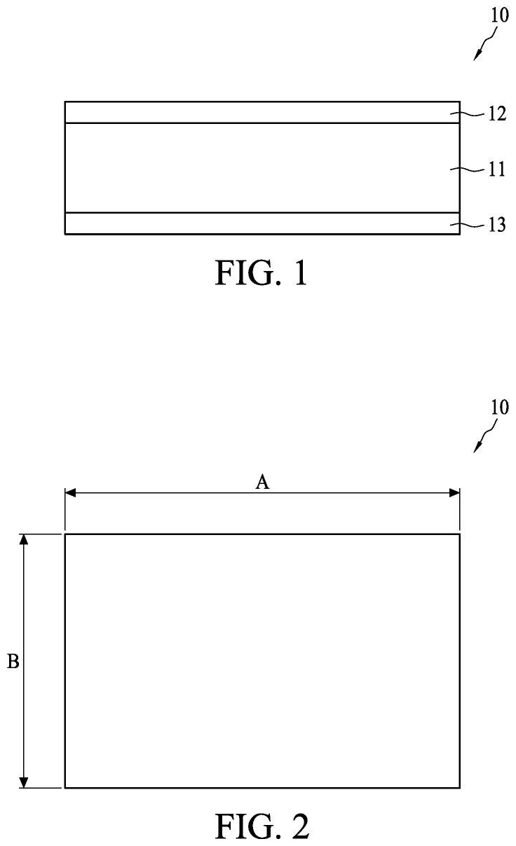

Please refer to FIG. 1. FIG. 1 shows one basic aspect of an over-current protection device 10 of the present invention in cross-sectional view. The over-current protection device 10 includes a heat-sensitive layer 11 and an electrode layer. The heat-sensitive layer 11 has a top surface and a bottom surface, and the electrode layer has a top metal layer 12 and a bottom metal layer 13 attached to the top surface and the bottom surface, respectively. Therefore, the heat-sensitive layer 11 physically contacts the top metal layer 12 and the bottom metal layer 13, and is laminated therebetween. In an embodiment, the top metal layer 12 and the bottom metal layer 13 may be composed of the nickel-plated copper foils or other conductive metals. In addition, the heat-sensitive layer 11 includes a polymer matrix and a conductive filler. The polymer matrix is an electrical insulator sensitive to heat and the conductive filler is a conductor, by which the heat-sensitive layer 11 exhibits PTC characteristic. The over-current protection device 10 does not operate under normal condition. Consequently, the conductive filler is uniformly dispersed in the polymer matrix and particles of the conductive filler connect to each other in series, forming an electrically conductive path. However, the polymer matrix rapidly expands when the over-current protection device 10 is subject to high temperature, and the particles of the conductive filler are pulled away from each other, thereby cutting off the electrically conductive path in the heat-sensitive layer 11.

In the present invention, the major constituent of the polymer matrix includes two types of fluoropolymers (referred to as “first fluoropolymer” and “second fluoropolymer” hereinafter) with different melting points and different flow properties. The first fluoropolymer may be one type of polyvinylidene difluoride with a higher melting point, while the second fluoropolymer may be another type of polyvinylidene difluoride, which has a chemical structural formula similar to or the same as the first fluoropolymer but possesses a lower melting point. More specifically, the first fluoropolymer has a first melting point and the second fluoropolymer has a second melting point lower than the first melting point, and a difference between the first melting point and the second melting point is less than 14° C. The second fluoropolymer not only has the lower melting point, but its flowability is also lower than that of the first fluoropolymer. The melt flow index is measured at 230° C. in accordance with the standard of ASTM D1238, and the first fluoropolymer has a first melt flow index, and the second fluoropolymer has a second melt flow index lower than the first melt flow index. The first melt flow index ranges from about 0.8 g/10 min to 1.4 g/10 min, and the second melt flow index ranges from about 0.4 g/10 min to 0.7 g/10 min. The first fluoropolymer and the second fluoropolymer together form the structure of interpenetrating polymer network (IPN), constituting the major constituent of the polymer matrix.

It is understood that the conventional over-current protection device typically uses a single type of fluoropolymer (e.g., single type of PVDF) as the polymer matrix for high-temperature overheating protection; if two fluoropolymers having the same monomer units but different physical or chemical properties (e.g., two different types of PVDF) are used, this often does not yield a substantial improvement or can even lead to poor performance in electrical characteristics. In the latter case, it is due to the complexity in formulation design. With the addition of each new compound, it's essential to consider the compatibility between the additional compound and the conventional polymer matrix, conductive filler, and other inner fillers. Even though the additional compound is compatible with the conventional polymer matrix, conductive filler and other inner fillers, the proportion between them needs to be adjusted properly in order to maintain excellent electric characteristics, or otherwise the aforementioned issue of insignificant improvement and poor performance arises. However, through the appropriate adjustment of material proportions and physical properties according to the present invention, it is found that the combination of two fluoropolymers surpasses a single fluoropolymer in composing the polymer matrix. More specifically, the introduction of an additional fluoropolymer that is more easily melted but less prone to flow (i.e., the second fluoropolymer) into the polymer matrix not only effectively stabilizes the material structure but also significantly improves its electrical characteristics. As the melting point of the second fluoropolymer is lower than that of the first fluoropolymer, it contributes to reducing the overall melting point of the polymer matrix, allowing for easier melting at high temperature and facilitating better blending with other materials. Although the second fluoropolymer is easily melted, it exhibits a significantly lower melt flow index (i.e., second melt flow index) compared to the first fluoropolymer. This property of low flowability is advantageous in maintaining the integrity of the structure of the over-current protection device 10, preventing excessive deformation, especially during alternating high and low temperatures (e.g., multiple trip events). It is noted that the second melt flow index should be carefully controlled within a specific range. If the second melt flow index is lower than 0.4 g/10 min, it becomes challenging to manage the proportion of the second fluoropolymer. Specifically, if the flowability of the second fluoropolymer is too low, even a slight variation in its proportion will overly affect the overall flowability of the matrix as well as its electrical characteristics. If the second melt flow index is higher than 0.7 g/10 min, the second fluoropolymer would become so flowable that its flowability cannot significantly differ from that of the first fluoropolymer; and, thus even with an increased proportion, it would not substantially enhance the overall flowability of the polymer matrix. In an embodiment, the second melt flow index ranges from about 0.4 g/10 min to 0.6 g/10 min, such as 0.4 g/10 min, 0.45 g/10 min, 0.5 g/10 min, 0.55 g/10 min, or 0.6 g/10 min.

Additionally, the second melting point of the second fluoropolymer is not only lower than the first melting point but also exhibits a difference from the first melting point. Besides the processing advantage described above, the present invention further takes the issue of polymer recrystallization into account, which is solved by adjusting the difference between the first melting point and the second melting point within a specific range. More specifically, the difference between the first melting point and the second melting point ranges from 5° C. to 14° C., such as 5° C., 6° C., 7° C., 8° C., 9° C., 10° C., 11° C., 12° C., 13° C., or 14° C. When the temperature decreases to the first melting point, the first fluoropolymer is in a solid state. Consequently, the second fluoropolymer utilizes the first fluoropolymer as the nucleation center and recrystallizes around it, restoring a stable crystalline state. In other words, the presence of the first fluoropolymer enhances the crystallization efficiency of the second fluoropolymer, which, in turn, supports the structural stability of the heat-sensitive resistor layer 11. This combination further enhances electrical performance. If the difference is less than 5° C., the phase transition behaviors of both polymers at the high temperature tend to synchronize, and therefore, the first fluoropolymer cannot effectively assist in the recrystallization of the second fluoropolymer. If the difference is greater than 14° C., there is the issue of phase separation between the first fluoropolymer and second fluoropolymer. The issue of phase separation primarily occurs when the temperature gradually decreases, resulting in a great disparity in their recrystallization processes. This disparity leads to inefficient formation of the IPN structure between the first fluoropolymer and the second fluoropolymer. More specifically, when the temperature decreases from high temperature to the first melting point, the first fluoropolymer starts to recrystallize and forms an order arrangement of crystals. As the temperature continues to decrease from the first melting point toward the second melting point, the crystalline arrangement of the first fluoropolymer gradually stabilizes. However, because of the significant difference between the first and second melting points, by the time the temperature approaches the second melting point, the structure of the first fluoropolymer has already solidified for a while. At this point, the second fluoropolymer is in the molten state and is just preparing to start recrystallizing, and therefore, a part of the second fluoropolymer may transform into the solid phase independent of the first fluoropolymer, rather than tangles with the first fluoropolymer to form the compatible structure (i.e., IPN structure). In the present invention, the second melting point of the second fluoropolymer may be 171° C. Considering the measurement error and according to the practical use, the second melting point of the second fluoropolymer may range from 168° C. to 174° C. while still achieving the same technical effect. The first melting point of the first fluoropolymer can be adjusted correspondingly based on the difference from the second melting point mentioned earlier. For example, if the second melting point is 168° C., the first melting point may range from 173° C. to 182° C.; if the second melting point is 171° C., the first melting point may range from 176° C. to 185° C.; or if the second melting point is 174° C., the first melting point may range from 179° C. to 188° C. Similarly, if the second melting point is 169° C., 170° C., 172° C., or 173° C., the first melting point can be deduced using the same way as described above. According to the aforementioned properties, the present invention further adjusts the content of the first fluoropolymer and the second fluoropolymer to an appropriate proportion. The total volume of the heat-sensitive layer 11 is calculated as 100%, and the first fluoropolymer accounts for 28% to 48% and the second fluoropolymer accounts for 10% to 30% by volume. It is noted that the maximum proportion of the second fluoropolymer (30%) is lower than the maximum proportion of the first fluoropolymer (48%). This is because the flowability of the second fluoropolymer is poorer, and therefore, the excessively high proportion of it makes the materials difficult to flow (i.e., unfavorable to the blending process) during the manufacture of the heat-sensitive layer 11. In the present invention, the proportion of the first fluoropolymer is higher than that of the second fluoropolymer. This aids in the blending of the polymers with the conductive filler, facilitating the production of the heat-sensitive resistor layer 11. In a preferred embodiment, the first fluoropolymer accounts for 29% to 46% by volume, and the second fluoropolymer accounts for 11% to 28% by volume.

In addition, the present invention determines that the second fluoropolymer can generate a similar or identical technical effect as long as it contains a core structure similar to that of the first fluoropolymer. More specifically, if the first fluoropolymer is polyvinylidene difluoride, the second fluoropolymer is represented by a structural formula (I):

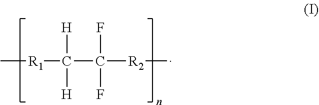

In the structural formula (I), a repeating unit is —CH₂CF₂— connected to two functional groups (i.e., R₁ and R₂), and is the core structure of the second fluoropolymer. R₁ and R₂ are selected from the group consisting of CH₂, CF₂, CHF, C₂HF₃, C₂H₂F₂, C₂H₃F, C₂H₄, and C₂F₄. R₁ is different from R2. For example, if R₁ is CH2, R₂ is selected from the group consisting of CF₂, CHF, C₂HF₃, C₂H₂F₂, C₂H₃F, C₂H₄, and C₂F₄. “n” is the repeating number of the repeating unit, and is at least 9000. In an embodiment, the second fluoropolymer may also be polyvinylidene difluoride, that is, R₁ is CF₂ and R₂ is CH₂.

Moreover, the polymer matrix of the present invention may further include a third fluoropolymer. The third fluoropolymer is selected from the group consisting of polytetrafluoroethylene, ethylene-tetrafluoroethylene copolymer, tetrafluoroethylene-hexafluoro-propylene copolymer, perfluoroalkoxy modified tetrafluoroethylenes, poly(chlorotri-fluorotetrafluoroethylene), vinylidene fluoride-tetrafluoroethylene copolymer, tetrafluoroethylene-perfluorodioxole copolymer, vinylidene fluoride-hexafluoropropylene copolymer, vinylidene fluoride-hexafluoropropylene-tetrafluoroethylene terpolymer, and any combination thereof. The melting point of the third fluoropolymer is much higher than that of the first fluoropolymer and the second fluoropolymer. For example, the melting points of the first fluoropolymer and the second fluoropolymer ranges from 168° C. to 188° C., and the melting point of the third fluoropolymer ranges from 320° C. to 335° C. If the environmental temperature is higher than the melting points of the first fluoropolymer and the second fluoropolymer but lower than the melting point of the third fluoropolymer, both the first fluoropolymer and the second fluoropolymer melt but the third fluoropolymer does not. In this manner, particles of the third fluoropolymer remain in the solid state and are uniformly dispersed within the heat-sensitive layer 11, thereby establishing nucleation sites for and favorable to the recrystallization of the first and second fluoropolymers. Additionally, the third fluoropolymer experiences less severe deformation because of its higher melting temperature when subject to high temperature. As a result, the structure of the heat-sensitive layer 11 is stabilized by the third fluoropolymer, preventing severe deformation. In an embodiment, the third fluoropolymer is polytetrafluoroethylene; and the total volume of the heat-sensitive layer is calculated as 100%, and the third fluoropolymer accounts for 4% to 6% by volume.

Besides the polymer matrix and the conductive filler described above, the heat-sensitive layer 11 further includes a flame retardant. The flame retardant is selected from the group consisting of zinc oxide, antimony oxide, aluminum oxide, silicon oxide, calcium carbonate, magnesium sulfate, barium sulfate, magnesium hydroxide, aluminum hydroxide, calcium hydroxide, barium hydroxide, and any combination thereof. In an embodiment, the flame retardant is preferably magnesium hydroxide. Magnesium hydroxide not only effectively reduces the flammability of the heat-sensitive layer 11 but also neutralizes the hydrofluoric acid produced by the fluoropolymers at high temperature.

Besides the improvement of the material composition, the over-current protection device 10 of the present invention may have different sizes. Please refer to FIG. 2, which shows the top view of the over-current protection device 10 shown in FIG. 1. The over-current protection device 10 has a length A and a width B, and the top-view area “A×B” of the over-current protection device 10 is substantially equivalent to the top-view area of the heat-sensitive layer 11. The heat-sensitive layer 11 may have a top-view area ranging from 4 mm² to 72 mm² based on different products having different sizes. For example, the top-view area “A×B” may be 2×2 mm², 4×4 mm², 5×5 mm², 5.1×6.1 mm², 5×7 mm², 7.62×7.62 mm², 7.8×8.15 mm², 7.3×9.5 mm², or 7.62×9.35 mm². In addition, the total thickness of the over-current protection device 10 (i.e., the total thickness of the top metal layer 12, the heat-sensitive layer 11, and the bottom metal layer 13) ranges from 0.18 mm to 0.24 mm. More specifically, the thickness of each of the upper metal layer 12 and the lower metal layer 13 is 0.035 mm, and the thickness of the heat-sensitive layer 11 correspondingly ranges from 0.11 mm to 0.17 mm, such as 0.11 mm, 0.12 mm, 0.13 mm, 0.14 mm, 0.15 mm, 0.16 mm, or 0.17 mm. In an embodiment, the top-view area of the over-current protection device 10 is 35 mm² (i.e., 5×7 mm²), and the thickness of it is 0.18 mm. In another embodiment, the top-view area of the over-current protection device 10 is 63.57 mm² (i.e., 7.8×8.15 mm²), and the thickness of it is 0.21 mm. It is understood that the present invention can apply to any size of the over-current protection device 10 described above to achieve the same technical effect. The over-current protection device 10 can be processed into different device types commonly used in the industry, such as surface-mount device (SMD), axial-leaded device (ALD), radial-leaded device (RLD), or other device types, depending on the requirements.

From the above, the over-current protection device 10 of the present invention can include many excellent electrical characteristics, and these electrical characteristics can be verified in the following tests: trip jump test, cycle life test, thermal derating effect test, and resistance-temperature test.

In the trip jump test, the over-current protection device 10 has a first resistance-jump ratio ranging from 1.3 to 1.5. More specifically, the over-current protection device 10 has an initial electrical resistance before any test, and has a second electrical resistance when cooled back to room temperature after being applied at 16V/40 A for 3 minutes. The first resistance-jump ratio is obtained by dividing the second electrical resistance by the initial electrical resistance. Continuous application of a specific power (16V/40 A) can trip the over-current protection device 10 of the present invention. In this way, the first resistance-jump ratio can be used to assess the resistance recovery capability of the over-current protection device 10 of the present invention after at least one trip event. In the present invention, the first resistance-jump ratio of the over-current protection device 10 preferably range from 1.33 to 1.48. In contrast, the first resistance-jump ratio of the conventional over-current protection device is at least 1.5, which is higher than the maximum of that (i.e., 1.48) of the over-current protection device 10 of the present invention. This suggests that the resistance recovery capability of the over-current protection device 10 of the present invention is better, and it can recover to a lower electrical resistance state after the trip event.

In the cycle life test, the over-current protection device has a second resistance-jump ratio ranging from 1.5 to 1.8. More specifically, the over-current protection device 10 has an initial electrical resistance before any test, and has a third electrical resistance when cooled back to room temperature after a cycle life test for 2000 cycles. The second resistance-jump ratio is obtained by dividing the third electrical resistance by the initial electrical resistance. One cycle of the cycle life test includes applying a specific power of 30V/40 A for 10 seconds and turning it off for 60 seconds (i.e., on: 10 seconds; off: 60 seconds), and the cycle number thereof is 2000. The cycle life test can be used to assess not only the endurance of the over-current protection device 10 (i.e., whether it is burnt out) but also its resistance recovery capability through the second resistance-jump ratio after multiple trip events in the test. After the cycle life test, the second resistance-jump ratio of the conventional over-current protection device is at least 1.98, which is much higher than the maximum of the second resistance-jump ratio of the over-current protection device 10 in the present invention (i.e., 1.8). The over-current protection device 10 of the present invention has better resistance recovery capability, and is able to recover to a lower resistance state after multiple trip events. It is noted that the electrical performance of the over-current protection device 10 in the present invention also exhibits better reproducibility. In the cycle life test, a standard deviation of the third electrical resistance of the over-current protection device 10 ranges from 0.0009 Ω to 0.0011 Ω. In contrast, a standard deviation of the third electrical resistance of the conventional over-current protection device is higher than 0.0015 Ω. It means that the electrical resistances of the over-current protection device 10 of the present invention are more consistent and the resistance change and/or variation will be much smaller than the conventional over-current protection device during mass production. It also suggests that the electrical characteristics of the device may remain stable, ensuring minimal variation during mass production.

In order to further assess the durability of the over-current protection device, the present invention performs other three different cycle life tests (referred to as first cycle life test, second cycle life test, and third cycle life test hereinafter). The first cycle life test is performed at a power of 24V/40 A, and the cycle number is 6700. The second cycle life test is performed at a power of 30V/40 A, and the cycle number is 3000. The third cycle life test is performed at a power of 36V/40 A, and the cycle number is 1000. It is noted that the over-current protection device 10 of the present invention can pass the first cycle life test, the second cycle life test, and the third cycle life test without burnout. That is, when the heat-sensitive layer 11 is extremely thin (0.11 mm-0.17 mm), the over-current protection device 10 of the present invention can withstand high power of 1400 W to 1500 W without burnout. In contrast, most examples of the conventional over-current protection device are burnt out and unusable when the applied power exceeds 1200 W.

In the thermal derating effect test, the over-current protection device 10 has a thermal derating ratio of trip current ranging from 35% to 42%. More specifically, the thermal derating ratio of trip current is defined as a value by dividing a required trip current of the over-current protection device under 125° C. by a required trip current of the over-current protection device under 25° C., and is represented by percentage. The thermal derating effect test is used to compare the difference between the required trip currents of the over-current protection device 10 at different environmental temperatures, and it can be used to assess the impact of high temperature on operational performance. Ideally, the user would expect the same (or similar) value of the required trip currents of the over-current protection device 10 under different environmental temperatures so that the over-current protection device 10 can perform its function of over-current protection at a stable preset current (i.e., the preset required trip current), offering operational convenience. In contrast, the thermal derating ratio of trip current of the conventional over-current protection device is lower than 34%, which is lower than the minimum of that of the over-current protection device 10 of the present invention (35%). From the above, the required trip current of the over-current protection device 10 of the present invention is less affected by temperature change, and can perform its function of over-current protection at a stable preset current, which is beneficial to the operational convenience.

In the resistance-temperature test, the over-current protection device 10 has a peak-resistance maintenance ratio ranging from 0.4 to 1.1. More specifically, the over-current protection device has a first peak resistance after tripping at 200° C. for one time, and has a second peak resistance after tripping at 200° C. for three times. The peak-resistance maintenance ratio is obtained by dividing the second peak resistance by the first peak resistance. The peak-resistance maintenance ratio can be used to assess the stability of the high electrical resistance state of the over-current protection device under the high temperature. After multiple trip events, the over-current protection device 10 of the present invention exhibits the peak-resistance maintenance ratio falling within the aforementioned range, and more importantly, the majority of these ratios are around 1. This indicates that the over-current protection device 10 of the present invention can still escalate to the high electrical resistance state, thereby maintaining excellent current cut-off capability even after multiple operations. In contrast, most peak-resistance maintenance ratios of the conventional over-current protection device are far below 0.3, which indicates that their resistance escalate to a lesser extent after multiple operations, resulting in poorer over-current protection capability.

As described above, the present invention allows the over-current protection device 10 to exhibit excellent electrical characteristics under high temperature. It can be verified according to the experimental data in Table 1 to Table 7 as shown below.

TABLE 1
Major polymers of the polymer matrix.

| Polymer | Melt flow index (g/10 min) | Melting point (° C.) |
|---|---|---|
| PVDF-1 | 1.1 | 181 |
| PVDF-2 | 0.55 | 171 |
| PVDF-3 | 1.5 | 170 |

TABLE 2
Volume percentage (vol %) of the heat-sensitive layer.

| Group | PVDF-1 | PVDF-2 | PVDF-3 | PTFE | Mg(OH)₂ | CB |
|---|---|---|---|---|---|---|
| E1 | 46.1 | 11 | 0 | 4.7 | 3.2 | 35 |
| E2 | 35.1 | 22 | 0 | 4.7 | 3.2 | 35 |
| E3 | 29.1 | 28 | 0 | 4.7 | 3.2 | 35 |
| C1 | 57.1 | 0 | 0 | 4.7 | 3.2 | 35 |
| C2 | 0 | 0 | 57.1 | 4.7 | 3.2 | 35 |
| C3 | 59 | 0 | 0 | 4.2 | 3.2 | 33.6 |

Table 1 shows the major polymers in the polymer matrix, that is, three types of polyvinylidene difluoride (PVDF) referred to as first polyvinylidene difluoride (PVDF-1), second polyvinylidene difluoride (PVDF-2), and third polyvinylidene difluoride (PVDF-3) hereinafter. Regarding melting point, the melting points of PVDF-1, PVDF-2, and PVDF-3 are 181° C., 171° C., and 170° C., respectively. Regarding melt flow index, it is measured in accordance with the standard of ASTM D1238. In these three types of PVDF, PVDF-2 exhibits the lowest melt flow index, which is 0.55 g/10 min; and PVDF-1 and PVDF-3 exhibit the higher ones, which are 1.1 g/10 min and 1.5 g/10 min, respectively.

Please refer to Table 2. Table 2 shows the volume percentage composition of the heat-sensitive layer in accordance with the embodiments (E1-E3) of the present disclosure and the comparative examples (C1-C3). The first column in Table 1 shows test groups E1-C3 from top to bottom. The first row in Table 1 shows various materials used for the heat-sensitive layer from left to right, that is, polyvinylidene fluoride (PVDF-1, PVDF-2, and PVDF-3), polytetrafluoroethylene (PTFE), magnesium hydroxide (Mg(OH)₂), and carbon black (CB). Magnesium hydroxide acts as the flame retardant, and can neutralize the hydrofluoric acid produced by the fluoropolymers at high temperature. To enhance the voltage endurance capability, the conductive filler consists of carbon black.

In the embodiments E1 to E3 of the present invention, the major constituent of the polymer matrix consists of two types of PVDF (PVDF-1 and PVDF-2), and the minor constituent of the polymer matrix is PTFE. Since PTFE has a much higher melting point (about 330° C.) than that of PVDF, the proportion of PTFE must not be too high to avoid affecting the protection temperature and other unexpectedly adverse issues to the trip event of the over-current protection device. Accordingly, the proportion of

PVDF to PTFE needs to be carefully controlled. It is noted that the major constituent of the polymer matrix has two types of PVDF with two different physical/chemical properties, rather than a single type of PVDF, which adds greater complexity to the formulation design. Considering the type of the flame retardant and the conductive filler, the optimal ratio of PVDF to PTFE of the present invention is approximately 12:1. Therefore, the combined volume percentage of PVDF-1 and PVDF-2 is about 57.1%, and the volume percentage of PTFE is 4.7%. Because of the lower flowability of PVDF-2 at the high temperature, an excessive amount of it would be disadvantageous for blending, pressing, or causing similar inconveniences during the process, thereby affecting the electrical characteristics. In other case with excessive amount of PVDF-2, if the subsequent irradiation process uses a higher irradiation dose to promote polymer cross-linking, bubbles are easily formed in the PTC composite material (i.e., the heat-sensitive resistor layer 11), leading to structural damage in the layer. The amount of PVDF-2 can be approximately lower or equal to the amount of PVDF-1. Considering the measurement error and according to the practical use, the ratio of PVDF-1 to PVDF-2 may range from 5:1 to 1:1, while still achieving the same technical effect.

In the comparative examples C1 to C3 of the present invention, the major constituent of the polymer matrix consists of single type of PVDF, and the minor constituent of the polymer matrix is PTFE. Conventionally, the polymer matrix consists of a single type of PVDF as its major constituent, based on the type of the flame retardant and the conductive filler. However, the use of either PVDF-1 or PVDF-3 results in poor electrical performance of the over-current protection device. Subsequent tests will demonstrate that the embodiments E1 to E3 of the present invention have better performance than the comparative examples C1 to C3.

The manufacturing process of the over-current protection devices of the embodiments E1 to E3 and the comparative examples C11 to C3 is described below. According to the composition shown in Table 2,materials are prepared and put into HAAKE twin screw blender for blending. The blending temperature is 215° C., the time for pre-mixing is 3 minutes, and the blending time is 15 minutes. The conductive polymer after being blended is pressed into a sheet by a hot press machine at a temperature of 210° C. and a pressure of 150 kg/cm². The sheet is then cut into pieces of about 20 cm×20 cm, and two nickel-plated copper foils are laminated to two sides of the sheet with the hot press machine at a temperature of 210° C. and a pressure of 150 kg/cm², by which a three-layered structure is formed. Then, the sheet with the nickel-plated copper foils is punched into PTC chips, each of which is the over-current protection device. Each sample of the over-current protection device has the length of 7.8 mm and the width of 8.15 mm (i.e., top-view area is 63.57 mm²), and the thickness thereof is 0.21 mm. Then, the PTC chips of the embodiments and comparative examples are subjected to electron beam irradiation of 200 kGy (irradiation dose can be adjusted depending on the requirement). After irradiation, the following measurements are performed by taking fifteen PTC chips as samples to be tested for each of the groups.

Table 3 to Table 7 show the results of trip jump test, cycle life test 1, cycle life test 2, thermal derating effect test, and resistance-temperature test.

TABLE 3
Trip jump test.

| | Rᵢ | ρᵢ | Rₜᵣᵢₚ | ρₜᵣᵢₚ | |
|---|---|---|---|---|---|
| Group | (Ω) | (Ω · cm) | (Ω) | (Ω · cm) | Rₜᵣᵢₚ/Rᵢ |
| E1 | 0.0184 | 0.5573 | 0.0273 | 0.8267 | 1.484 |
| E2 | 0.0229 | 0.6919 | 0.0316 | 0.9565 | 1.383 |
| E3 | 0.0242 | 0.7311 | 0.0322 | 0.9747 | 1.333 |
| C1 | 0.0150 | 0.4552 | 0.0226 | 0.6852 | 1.505 |
| C2 | 0.0193 | 0.5828 | 0.0328 | 0.9940 | 1.706 |
| C3 | 0.0198 | 0.6002 | 0.0310 | 0.9398 | 1.566 |

As shown in Table 3, the first row shows items to be tested from left to right.

“Rᵢ” refers to the initial electrical resistance of the over-current protection device at room temperature.

“Rₜᵣᵢₚ” refers to the electrical resistance of the over-current protection device when it is cooled back to room temperature after being applied at 16V/40 A for 3 minutes. Accordingly, Rₜᵣᵢₚ/Rᵢ can be calculated, and this is the first resistance-jump ratio as previously mentioned.

In addition, the electrical resistance formula is ρ=R×A/L, where “R” is electrical resistance, “L” is length (thickness), and “A” is cross sectional area. Accordingly, the electrical resistivity ρᵢ and ρₜᵣᵢₚ can be calculated based on Rᵢ and Rₜᵣᵢₚ.

The over-current protection device, also known as a resettable fuse, can return to a low electrical resistance state when cooled down after tripping. Therefore, its resistance recovery capability is quite important after tripping. If the resistance recovery capability is good, the over-current protection device can be reused several times without replacement, ensuring it does not compromise the normal operation of other components it protects. This also suggests that the electrical resistance of the over-current protection device remains stable. The first resistance-jump ratio (Rₜᵣᵢₚ/Rᵢ) is the resistance recovery capability after a single trip event. The lower the value, the better the ability of the over-current protection device to restore to a low electrical resistance state. As shown in Table 3, the first resistance-jump ratio (Rₜᵣᵢₚ/Rᵢ) of the embodiments E1-E3 ranges from 1.333 to 1.484, and the first resistance-jump ratio (Rₜᵣᵢₚ/Rᵢ) of the comparative examples C1-C3 ranges from 1.505 to 1.706. It is noted that the maximum of the first resistance-jump ratio (Rₜᵣᵢₚ/Rᵢ) among the embodiments E1-E3 is lower than the minimum of the first resistance-jump ratio (Rₜᵣᵢₚ/Rᵢ) among the comparative examples C1-C3. This indicates that all the first resistance-jump ratios (Rₜᵣᵢₚ/Rᵢ) of the embodiments are lower than those of the comparative examples. From the above, it is clear that the resistance recover capability and the resistance stability of the over-current protection device 10 of the present invention are much better compared to the conventional over-current protection device.

TABLE 4
Cycle life test 1.

| | R_{2000C} | | SD of R_{2000C} |
|---|---|---|---|
| Group | (Ω) | R_{2000C}/Rᵢ | (Ω) |
| E1 | 0.0328 | 1.780 | 0.000934 |
| E2 | 0.0384 | 1.682 | 0.001098 |
| E3 | 0.0382 | 1.583 | 0.001092 |
| C1 | 0.0299 | 1.989 | 0.002042 |
| C2 | 0.0455 | 2.364 | 0.003598 |
| C3 | 0.0428 | 2.158 | 0.001598 |

As shown in Table 4, the first row shows items to be tested from left to right.

“R_{2000C}” refers to the electrical resistance of the over-current protection device when it is cooled back to room temperature after 2000 cycles of the cycle life test 1. One cycle of the cycle life test 1 includes applying a specific power of 30V/40 A for 10 seconds and turning it off for 60 seconds (i.e., on: 10 seconds; off: 60 seconds), and the cycle number thereof is 2000.

The cycle life test is different from the trip jump test. It involves applying the specific high power for several times, which can repeatedly trigger the trip event to the device. The cycle life test can be used to further assess the resistance stability of the over-current protection device after multiple trip events. R_{2000C}/Rᵢ is the second resistance-jump ratio as previously mentioned, which can be used to assess the resistance stability after multiple trip events. The second resistance-jump ratio (R_{2000C}/Rᵢ) of the embodiments E1-E3 ranges from 1.583 to 1.78, and the second resistance-jump ratio (R_{2000C}/Rᵢ) of the comparative examples C1-C3 ranges from 1.989 to 2.364. Likewise, all the second resistance-jump ratios (R_{2000C}/Rᵢ) of the comparative examples are higher than those of the embodiments. It shows that the resistance recover capability and the resistance stability of the over-current protection device 10 of the present invention are much better compared to the conventional over-current protection device.

In addition, in order to verify consistency during mass production of the over-current protection device of the present invention, standard deviation (SD) of R_{2000C} is further calculated according to the following SD formula:

$$S = \sqrt{\frac{\sum {( {x}_{i} - \overline{x} )}^{2}}{n}}$$

“S” stands for standard deviation. “n” is the total number of samples. As described above, fifteen PTC chips are tested in each group, and thus n is 15. “xᵢ” is individual value in respect of R_{2000C} of each PTC chip. “x̅” is the mean of all values of R_{2000C} of 15 PTC chips. In Table 4, SD of R_{2000C} of the embodiments E1 to E3 ranges from 0.000934 Ω to 0.001098 Ω, and this range is much lower than that of the comparative examples C1 to C3 ranging from 0.001598 Ω to 0.003598 Ω. The above data shows that, in each group of E1-E3, the resistance change or variation between 15 over-current protection devices is small after the cycle life test. In other words, the electrical resistances of the over-current protection devices are more consistent with each other during mass production.

TABLE 5
Cycle life test 2.

| | | | | Endurable |
|---|---|---|---|---|
| | 24 V/ | 30 V/ | 36 V/ | power |
| Group | 40 A_6700 C | 40 A_3000 C | 40 A_1000 C | (W) |
| E1 | Pass | Pass | Pass | 1440 |
| E2 | Pass | Pass | Pass | 1440 |
| E3 | Pass | Pass | Pass | 1440 |
| C1 | Pass | Fail | Fail | 1200 |
| C2 | Pass | Fail | Fail | 1200 |
| C3 | Pass | Pass | Pass | 1440 |

In order to assess the durability of the over-current protection device, three different cycle life tests are further conducted.

“24V/40A_6700C” refers to the first cycle life test, which involves an applied power of 24V/40 A for 6700 cycles. “30V/40A_3000C” refers to the second cycle life test, which involves an applied power of 30V/40 A for 3000 cycles. “36V/40A_1000C” refers to the third cycle life test, which involves an applied power of 36V/40 A for 1000 cycles.

In Table 5, the embodiments E1 to E3 of the present invention can pass the first cycle life test, the second cycle life test, and the third cycle life test without burnout. However, all devices of the comparative examples C1 and C2 are burnt out during the second cycle life test and the third cycle life test, and only the comparative example C3 can pass the above three cycle life tests. In other words, most examples of the conventional device cannot withstand repeated shocks of high power exceeding 1200 W. The over-current protection device 10 of the present invention has excellent durability, enduring the applied power up to 1440 W for 1000 cycles without burnout.

TABLE 6
Thermal derating effect test.

| | | | Endurable | | |
|---|---|---|---|---|---|
| | | | power per | | I-T_{125° C.}/ |
| | I-T_{25°} _{C.} | I-T_{25°} _{C.}/area | unit area | I-T_{125° C.} | I-T_{25° C.} |
| Group | (A) | (A/mm²) | (W/mm²) | (A) | (%) |
| E1 | 7.50 | 0.118 | 4.25 | 3.09 | 41.2 |
| E2 | 7.10 | 0.112 | 4.02 | 2.75 | 38.7 |
| E3 | 7.00 | 0.110 | 3.96 | 2.58 | 36.9 |
| C1 | 7.70 | 0.121 | 3.63 | 2.59 | 33.6 |
| C2 | 6.95 | 0.109 | 3.28 | 2.12 | 30.5 |
| C3 | 7.01 | 0.110 | 3.97 | 2.32 | 33.1 |

As shown in Table 6, the first row shows items to be tested from left to right.

“I-T_{25° C.}” and “I-T_{125° C.}” refer to trip currents of the over-current protection device under the environmental temperature of 25° C. and 125° C., respectively. “I-T_{25° C.}/area” refers to the trip current per unit area of the over-current protection device under the environmental temperature of 25° C. It is noted that the applied voltage ranges from 30V to 36V when the devices are tripped, and therefore the endurable power per unit area of the over-current protection device under 25° C. can be calculated accordingly.

“I-T_{125° C.}/I-T_{25° C.}” refers to the thermal derating ratio of trip current as previously mentioned. For ease of discussion, the value of I-T_{125° C.} divided by I-T_{25° C.} is converted to percentage as shown in Table 6. As described above, the over-current protection device requires different trip currents at different temperatures. In the relatively low temperature environment, the over-current protection device has a lower electrical resistance, leading to a relatively higher required trip current. In the relatively high temperature environment, the over-current protection device has a higher electrical resistance, leading to a relatively lower required trip current. Therefore, the thermal derating ratio of trip current (I-T_{125° C.}/I-T_{25° C.}) can be used to assess the impact of rising temperature on the operational convenience. The thermal derating ratio of trip current (I-T_{125° C.}/I-T_{25° C.}) of the embodiments E1 to E3 ranges from 36.9% to 41.2%, and the thermal derating ratio of trip current (I-T_{125° C.}/I-T_{25° C.}) of the comparative examples C1 to C3 ranges from 30.5% to 33.6%. Apparently, all the thermal derating ratios of trip current (I-T_{125° C.}/I-T_{25° C.}) of the embodiments E1 to E3 are much higher, suggesting that the trip current is relatively stable under varying temperature. In contrast, in the comparative examples C1 to C3, the thermal derating ratio of trip current (I-T_{125° C.}/I-T_{25° C.}) could be as low as 30.5%, indicating that the trip current at 125° C. is far less than half of that at 25° C. and demonstrating considerable instability. From the above, it is clear that within the temperature range where the device remains untripped, the embodiments E1 to E3 of the present invention offer a more stable over-current protection function, enhancing operational convenience.

TABLE 7
Resistance-temperature test.

| Group | Rₘₐₓ₁ | Rₘₐₓ₃ | Rₘₐₓ₃/Rₘₐₓ₁ |
|---|---|---|---|
| E1 | 2.734 × 10⁵ | 1.339 × 10⁵ | 0.49 |
| E2 | 1.784 × 10⁵ | 1.859 × 10⁵ | 1.04 |
| E3 | 1.334 × 10⁵ | 1.459 × 10⁵ | 1.09 |
| C1 | 2.919 × 10⁵ | 2.561 × 10⁴ | 0.09 |
| C2 | 1.278 × 10³ | 3.769 × 10² | 0.29 |
| C3 | 2.058 × 10⁵ | 1.590 × 10⁴ | 0.08 |

The resistance-temperature test is conducted to assess the stability of high electrical resistance state of the over-current protection device after tripping. In the resistance-temperature test, the over-current protection device is placed in a heating apparatus, and the electrical resistances of the over-current protection device can be observed at specific temperatures. The heating apparatus continuously increases the temperature from 40° C. to 230° C. at a rate of 5° C./min. The over-current protection device can be tripped, reaching to a high electrical resistance state, with the highest resistance at 200° C. At this temperature point, the electrical resistance can be measured and referred to as the peak resistance.

It is understood that after multiple trip events, the ability of the over-current protection device to escalate to the high electrical resistance state could be compromised. The resistance-temperature test can be conducted for many cycles to observe the resistance change at 200° C. The process of rising from the low temperature (40° C.) to the high temperature (230° C.) and then lowering back to the low temperature (40° C.) constitutes one cycle. The peak resistance Rₘₐₓ₁, which is the first peak resistance as previously mentioned, can be measured at 200° C. at the first cycle of the resistance-temperature test. The peak resistance Rₘₐₓ₃, which is the second peak resistance as previously mentioned, can be measured at 200° C. at the third cycle of the resistance-temperature test. The ratio between Rₘₐₓ₃ and Rₘₐₓ₁ (Rₘₐₓ₃/Rₘₐₓ₁) can be used to assess the stability of the high electrical resistance state, which can also be referred to as the peak-resistance maintenance ratio. As shown in Table 7, the peak-resistance maintenance ratio (Rₘₐₓ₃/Rₘₐₓ₁) of the embodiments E1 to E3 ranges from 0.49 to 1.09, and all values in this range are much higher than 0.29 (i.e., the ratio observed in the best comparative example C2). Notably, the embodiments E2 and E3 demonstrate their peak-resistance maintenance ratios (Rₘₐₓ₃/Rₘₐₓ₁) consistently around 1. This indicates that after three cycles of the resistance-temperature test, their resistances during high electrical resistance state can still reach almost the same level. From the above, the over-current protection device 10 of the present invention can maintain a stable resistance jump ability after tripping, demonstrating excellent resistance stability.

The above-described embodiments of the present invention are intended to be illustrative only. Numerous alternative embodiments may be devised by persons skilled in the art without departing from the scope of the following claims.

What is claimed is:

1. An over-current protection device, comprising:
an electrode layer having a top metal layer and a bottom metal layer; and
a heat-sensitive layer contacting the top metal layer and the bottom metal layer, and being laminated therebetween, wherein the heat-sensitive layer exhibits a positive temperature coefficient (PTC) characteristic and comprises:
a polymer matrix comprising a first fluoropolymer and a second fluoropolymer, wherein:
the first fluoropolymer has a first melting point and a first melt flow index;
the second fluoropolymer has a second melting point lower than the first melting point, and a difference between the first melting point and the second melting point is less than 14° C.; and
the second fluoropolymer has a second melt flow index ranging from 0.4 g/10 min to 0.7 g/10 min; and
a conductive filler dispersed in the polymer matrix, thereby forming an electrically conductive path in the heat-sensitive layer.

2. The over-current protection device of claim 1, wherein the difference between the first melting point and the second melting point ranges from 5° C. to 14° C.

3. The over-current protection device of claim 1, wherein the total volume of the heat-sensitive layer is calculated as 100%, and the first fluoropolymer accounts for 28% to 48% and the second fluoropolymer accounts for 10% to 30% by volume.

4. The over-current protection device of claim 1, wherein the second fluoropolymer is represented by a structural formula (I): 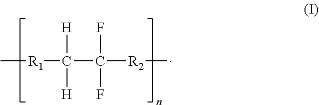
wherein:
R₁ and R₂ are selected from the group consisting of CH₂, CF₂, CHF, C₂HF₃, C₂H₂F₂, C₂H₃F, C₂H₄, and C₂F₄;
R₁ is different from R₂; and
n is at least 9000.

5. The over-current protection device of claim 1, wherein the second melting point of the second fluoropolymer ranges from 168° C. to 174° C.

6. The over-current protection device of claim 1, wherein the first melt flow index ranges from 0.8 g/10 min to 1.4 g/10 min.

7. The over-current protection device of claim 1, wherein the second fluoropolymer is polyvinylidene difluoride.

8. The over-current protection device of claim 1, wherein the polymer matrix further comprises a third fluoropolymer selected from the group consisting of polytetrafluoroethylene, ethylene-tetrafluoroethylene copolymer, tetrafluoroethylene-hexafluoro-propylene copolymer, perfluoroalkoxy modified tetrafluoroethylenes, poly(chlorotri-fluorotetrafluoroethylene), vinylidene fluoride-tetrafluoroethylene copolymer, tetrafluoroethylene-perfluorodioxole copolymer, vinylidene fluoride-hexafluoropropylene copolymer, vinylidene fluoride-hexafluoropropylene-tetrafluoroethylene terpolymer, and any combination thereof.

9. The over-current protection device of claim 8, wherein the third fluoropolymer is polytetrafluoroethylene, wherein the total volume of the heat-sensitive layer is calculated as 100%, and polytetrafluoroethylene accounts for 4% to 6% by volume.

10. The over-current protection device of claim 1, wherein the heat-sensitive layer further comprises a flame retardant selected from the group consisting of zinc oxide, antimony oxide, aluminum oxide, silicon oxide, calcium carbonate, magnesium sulfate, barium sulfate, magnesium hydroxide, aluminum hydroxide, calcium hydroxide, barium hydroxide, and any combination thereof.

11. The over-current protection device of claim 1, wherein the conductive filler consists of carbon black.

12. The over-current protection device of claim 1, wherein the over-current protection device has a first resistance-jump ratio ranging from 1.3 to 1.5, wherein:
the over-current protection device has an initial electrical resistance;
the over-current protection device has a second electrical resistance when cooled back to room temperature after being applied at 16V/40 A for 3 minutes; and
the first resistance-jump ratio is obtained by dividing the second electrical resistance by the initial electrical resistance.

13. The over-current protection device of claim 1, wherein the over-current protection device has a second resistance-jump ratio ranging from 1.5 to 1.8, wherein:
the over-current protection device has an initial electrical resistance;
the over-current protection device has a third electrical resistance when cooled back to room temperature after a cycle life test with an applied power of 30V/40 A for 2000 cycles; and
the second resistance-jump ratio is obtained by dividing the third electrical resistance by the initial electrical resistance.

14. The over-current protection device of claim 13, wherein a standard deviation of the third electrical resistance ranges from 0.0009 Ω to 0.0011 Ω.

15. The over-current protection device of claim 1, wherein the heat-sensitive layer has a thickness ranging from 0.11 mm to 0.17 mm, and an endurable power of the over-current protection device ranges from 1400 W to 1500 W.

16. The over-current protection device of claim 1, wherein the over-current protection device has a thermal derating ratio of trip current ranging from 35% to 42%, wherein the thermal derating ratio of trip current is obtained by dividing a required trip current of the over-current protection device under 125° C. by a required trip current of the over-current protection device under 25° C., and is represented by percentage.

17. The over-current protection device of claim 1, wherein the over-current protection device has a peak-resistance maintenance ratio ranging from 0.4 to 1.1, wherein:
the over-current protection device has a first peak resistance after tripping at 200° C. for one time;
the over-current protection device has a second peak resistance after tripping at 200° C. for three times; and
the peak-resistance maintenance ratio is obtained by dividing the second peak resistance by the first peak resistance.
